(19) United States
(12) Patent Application Publication
(10) Pub. No.: US 2013/0251947 A1
(43) Pub. Date: Sep. 26, 2013

(54) OPTICAL FILM

(71) Applicant: CRYSOPTIX KK, Tokyo (JP)

(72) Inventor: Alexander Lazarev, San Francisco, CA (US)

(73) Assignee: CRYSOPTIX KK, Tokyo (JP)

(21) Appl. No.: 13/762,835

(22) Filed: Feb. 8, 2013

Related U.S. Application Data
(60) Provisional application No. 61/597,607, filed on Feb. 10, 2012.

(51) Int. Cl. G02B 1/04; G02B 1/10

(52) U.S. Cl. CPC G02B 1/04; G02B 1/10
USPC 428/142; 428/435; 428/474.4; 428/161; 428/354; 428/475.2; 428/476.3; 428/412; 428/476.9; 428/473.5; 428/212; 524/606

(57) ABSTRACT

The present invention relates generally to optical retardation films. The invention may be used as optical element in liquid crystal display (LCD) devices, particularly as phase-shifting component of LCDs of both reflection and transmission type, and in ant other field of science and technology where optical retardation films are applied such as architecture, automobile industry, decoration arts. The present invention provides an optical film comprising a substrate having front and rear surfaces, and at least one solid optical retardation layer on the front surface of the substrate. The solid optical retardation layer comprises organic rigid rod-like macromolecules based on 2,2′-disulfo-4,4′-benzidine terephthalamide-isophthalamide copolymer or its salt of the general structural formula I. The solid optical retardation layer is a negative C-type or Ac-type plate substantially transparent to electromagnetic radiation in the visible spectral range.

### CROSS REFERENCE TO RELATED APPLICATIONS

This application is related to U.S. patent application Ser. No. 12/628,398 filed on Dec. 1, 2009, entitled “Organic Polymer Compound, Optical Film and Method”, the entire disclosure of which is incorporated by reference herein.

### FIELD OF THE INVENTION

The present invention relates to optical retardation films. The invention may be used as optical element in liquid crystal display (LCD) devices, particularly as phase-shifting component of LCDs of both reflection and transmission type, and in any other field of science and technology where optical retardation films are applied.

### BACKGROUND OF THE INVENTION

The liquid crystal display (LCD) technology has made a remarkable progress in the past years. Cellular phones, laptops, monitors, TV sets and even public displays based on LCD panels are presented on the market. LCD market is expected to keep growing in the near future and it sets new tasks for researchers and manufacturers. Among the key growth sustainers are product quality improvement and cost reduction.

Growing size of a LCD diagonal, which has already exceeded 100 inch size, imposes stronger restrictions onto the quality of optical components. In case of retardation films, very small color shift and ability to provide higher contrast ratio at wide viewing angles are required for high-quality viewing of large displays.

Nowadays there are still some disadvantages of LCD technology which impact quality of liquid crystal displays and still make feasible competitive technologies as for example plasma display panel (PDP). One of disadvantages is a decrease of contrast ratio at oblique viewing angles. In conventional LCDs the viewing angle performance is strongly dependent upon polarizers' performance. Typical LCD comprises two dichroic polarizers crossed at 90°. However, at oblique angles an angle between projections of their axes deviates from 90°, and the polarizers become uncrossed. Light leakage increases with increasing of an off-axis oblique angle. This results in a low contrast ratio at wide viewing angle along the bisector of crossed polarizers. Moreover, the light leakage becomes worse because of the liquid crystal cell placed between crossed polarizers.

Thus, technological progress poses the task of developing new optical elements based on new materials with controllable properties. In particular, the necessary optical element in modern visual display systems is an optically anisotropic birefringent film which is optimized for the optical characteristics of an individual LCD module.

Various polymer materials are known in the prior art, which are intended for use in the production of optically anisotropic birefringent films. Optical films based on these polymers acquire optical anisotropy through uniaxial extension.

Triacetyl cellulose films are widely used as negative C plates in modern LCD polarizers. However, their disadvantage is a low value of birefringence. Thinner films with high retardation value are required for making displays cheaper and lighter.

Besides stretching of the amorphous polymer films, other polymer alignment technologies are known in the art. Thermotropic liquid crystalline polymers (LCP) can provide highly anisotropic films characterized by various types of birefringence. Manufacturing of such films comprises coating a polymer melt or solution on a substrate, and in the latter case the coating step is followed by the solvent evaporation. Additional alignment actions are involved as well, such as an application of the electric field, or using of the alignment layer or coating on a stretched substrate. The after-treatment of the coating is set at a temperature at which the applied polymer exhibits liquid crystalline phase and for a time sufficient for the polymer molecules to be oriented. Examples of uniaxial and biaxial optical films production can be found in different patent documents and scientific publications in the art.

In the article by Li et al, Polymer, vol. 38, no. 13, pp. 3223-3227 (1997) the authors noted that some polymers provide optical anisotropy which is fairly independent of film thickness. They described special molecular order of rigid-chain polymers on the substrate. The director of molecules is preferentially in the plane of the substrate and has no preferred direction in the plane as shown in FIG. 1 (prior art). However, the described method has a technological drawback. The solution is applied onto a hot substrate, and the samples were dried at an elevated temperature of 150° C. in vacuum.

Shear-induced mesophase organization of synthetic polyelectrolytes in aqueous solution was described by T. Funaki et al. in Langmuir, vol. 20, 6518-6520 (2004). Poly(2,2′-disulfonylbenzidine terephtalamide (PBDT) was prepared by an interfacial polycondensation reaction according to the procedure known in the art. Using polarizing microscopy, the authors observed lyotropic nematic phase in aqueous solutions in the concentration range of 2.8-5.0 wt %. Wide angle X-ray diffraction study indicated that in the nematic state the PBDT molecules show an inter-chain spacing, d, of 0.30-0.34 nm, which is constant regardless of the concentration (2.8-5.0 wt %). The d value is smaller than that of the ordinary nematic polymers (0.41-0.45 nm), suggesting that PBDT rods in the nematic state have a strong inter-chain interaction in the nematic state to form the bundle-like structure despite the electrostatic repulsion of sulfonate anions.

A number of rigid rod water-soluble polymers were described by N. Sarkar and D. Kershner in Journal of Applied Polymer Science, Vol. 62, pp. 393-408 (1996). The authors suggest using these polymers in different applications such as an enhanced oil recovery. For these applications it is essential to have a water soluble shear stable polymer that can possess high viscosity at very low concentration. It is known that rigid rod polymers can be of high viscosity at low molecular weight compared with the traditionally used flexible chain polymers such a hydrolyzed poly-acrylamides. New sulfonated water soluble aromatic polyamides, polyureas, and polyimides were prepared via interfacial or solution polymerization of sulfonated aromatic diamines with aromatic dianhydrides, diacid chlorides, or phosgene. Some of these polymers had sufficiently high molecular weight (<200 000 according to GPC data), extremely high intrinsic viscosity (˜65 dL/g), and appeared to transform into a helical coil in salt solution.

The present invention provides solutions to the above referenced disadvantages of the optical films for liquid crystal display or other applications, and discloses an optical film, in particular, a uniaxial negative C-type plate and a biaxial A_{C}-type plate retardation layer, based on water-soluble rigid-core polymers and copolymers.

### SUMMARY OF THE INVENTION

The present invention provides an optical film comprising a substrate having front and rear surfaces, and at least one solid optical retardation layer on the front surface of the substrate. The solid optical retardation layer comprises organic rigid rod-like macromolecules based on 2,2′-disulfo-4,4′-benzidine terephthalamide-isophthalamide copolymer or its salt of the general structural formula I

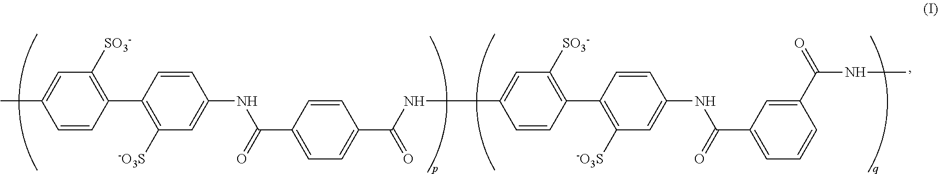

where p and q are numbers of the organic units in the rigid copolymer macromolecule which are in the range from 5 to 1000, the side-groups SO₃ provide solubility of the organic rigid rod-like copolymer macromolecules or its salts in an aqueous solvent, and counterions. At least one counterion is selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Al³⁺, Gd³⁺, Zr⁴⁺ and NH₄₋ₖQₖ⁺, where Q are independently selected from the list comprising linear and branched (C1-C20) alkyl, (C2-C20) alkenyl, (C2-C20) alkinyl, and (C6-C20)arylalkyl, and k is 0, 1, 2, 3 or 4. The solid optical retardation layer is a negative C-type or Ac-type plate substantially transparent to electromagnetic radiation in the visible spectral range.

### BRIEF DESCRIPTION OF THE DRAWINGS

FIG. 1 (prior art) schematically illustrates an arrangement of rigid chain polymer molecules on a substrate.

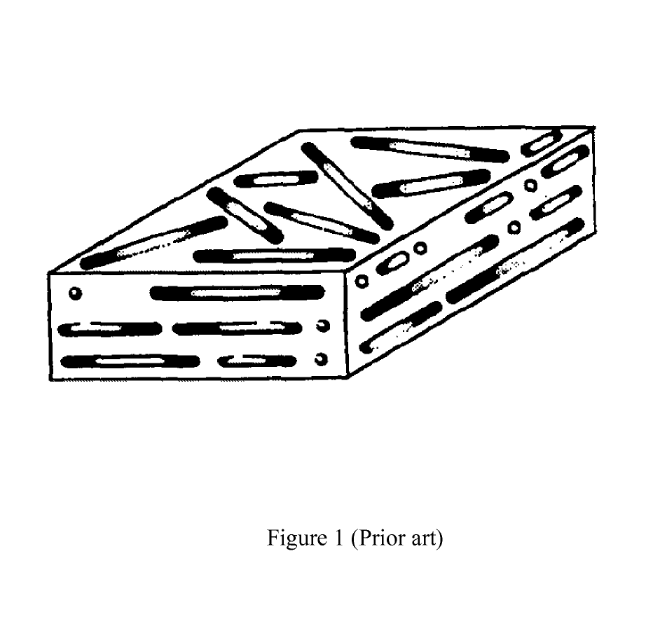

FIG. 2 shows spectra of the principal refractive indices of the organic retardation layer prepared with 2,2′-disulfo-4,4′-benzidine terephthalamide-isophthalamide copolymer cesium salt on a glass substrate; terephthalamide/isophthalamide molar ratio in the copolymer is 50:50.

FIG. 3 shows spectra of the principal refractive indices of the organic retardation layer prepared with 2,2′-disulfo-4,4′-benzidine terephthalamide-isophthalamide copolymer cesium salt on a glass substrate; terephthalamide/isophthalamide molar ratio in the copolymer is 92:8.

FIG. 4 shows a sectional view of the embodiment of the disclosed optical film comprising retardation layer with adhesive and protective layers.

FIG. 5 shows a sectional view of the disclosed optical film comprising an antireflector layer.

FIG. 6 shows a sectional view of the disclosed optical film comprising a reflective layer.

FIG. 7 shows a sectional view of the disclosed optical film comprising a diffusive or specular reflector as a substrate.

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 700 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer.

The term “optically anisotropic retardation layer of negative C-type” refers to an optical layer which refractive indices nₓ, n_{y}, and n_{z} obey the following condition in the visible spectral range: n_{z}<nₓ=n_{y}.

The term “optically anisotropic retardation layer of A_{C}-type” refers to an optical layer which refractive indices nₓ, n_{y}, and n_{z} obey the following condition in the visible spectral range: n_{z}<n_{y}<nₓ.

The term “NZ-factor” refers to the quantitative measure of degree of biaxiality which is calculated as follows:

$$NZ = \frac{Max ( {n}_{x} , {n}_{y} ) - {n}_{z}}{Max ( {n}_{x} , {n}_{y} ) - Min ( {n}_{x} , {n}_{y} )}$$

The term “thickness retardation Rₜₕ” refers to a retardation of a retardation layer, substrate or plate which is defined with the following expression: Rₜₕ=[n_{z}−(nₓ+n_{y})/2]·d, where d is a thickness of the retardation layer, substrate or plate.

The term “in-plane retardation Rₒ” refers to a retardation of a retardation layer, substrate or plate which is defined with the following expression: Rₒ=(nₓ−n_{y})·d, where d is a thickness of the retardation layer, substrate or plate.

The above mentioned definitions are invariant to rotation of system of coordinates (of the laboratory frame) around of the vertical z-axis for all types of anisotropic layers.

The present invention provides an optical film as disclosed hereinabove. In one embodiment of the present invention, the disclosed optical film further comprises inorganic compounds which are selected from the list comprising hydroxides and salts of alkaline metals. In one embodiment of the optical film, said solid retardation layer is an uniaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the following condition: n_{z}<n_{y}=n_{y}. The organic rigid rod-like macromolecules are preferentially directed in the plane of the substrate in isotropic manner, In another embodiment of the optical film, said solid retardation layer is a biaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the condition: n_{z}<n_{y}<nₓ. In yet another embodiment of the optical film, the substrate material is selected from the list comprising polymer and glass. A substrate for the optical film may be made of either glass of a transparent polymer, for example, polyethylene terephthalate (PET), polycarbonate, and cellulose acetate. The substrate transmission coefficient must be not lower than 80%, preferably not lower than 90%. The substrate may be also optically anisotropic. In addition, the substrate must protect the film from mechanical damage; this requirement determines the substrate thickness and strength.

In still another embodiment of the present invention, the disclosed optical further comprises at least one additional layer—an interlayer formed between the substrate and the solid optical retardation layer. In one embodiment of the optical film, the surface of the interlayer facing the solid optical retardation layer is hydrophilic. In another embodiment of the optical film, the surface of the interlayer facing the solid optical retardation layer bears a relief. In yet another embodiment of the optical film, the surface of the interlayer facing the solid optical retardation layer possesses a texture.

In still another embodiment of the optical film, the interlayer is a planarization layer between the substrate and the solid optical retardation layer.

In one embodiment of the optical film, the rear surface of the substrate is further covered with an antireflection or antiflashing coating.

In one embodiment of the present invention, the disclosed optical film further comprises an additional adhesive transparent layer formed on the solid optical retardation layer.

In another embodiment of the present invention, the disclosed optical film further comprises a protective layer formed on the adhesive layer.

In one embodiment of the optical film, the substrate is a specular or diffusive reflector. In another embodiment of the optical film, the substrate is a specular or diffusive transflector. In yet another embodiment of the optical film, the substrate is a reflective polarizer. In still another embodiment of the optical film, the substrate transmission is not less than 90% in the visible range. In yet another embodiment of the optical film, the polymer substrate material is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and polyester.

In one embodiment of the optical film, a thickness retardation Rₜₕ of the solid optical retardation layer is in the range from −210 nm to −320 nm, and the substrate is characterized by an in-plane retardation Rₒ which is in the range from 30 nm to 45 nm and by a thickness retardation Rₜₕ which is in the range from −120 nm to −230 nm.

In order that the invention may be more readily understood, reference is made to the following examples, which are intended to be illustrative of the invention, but are not intended to be limiting the scope.

### EXAMPLES

### Example 1

The example describes synthesis of 2,2′-disulfo-4,4′-benzidine terephthalamide-isophthalamide copolymer cesium salt.

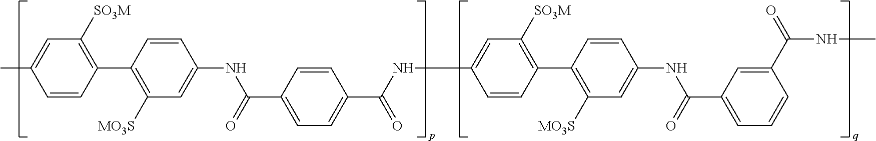

The same method of synthesis can be used for preparation of the copolymers of different molar ratio.

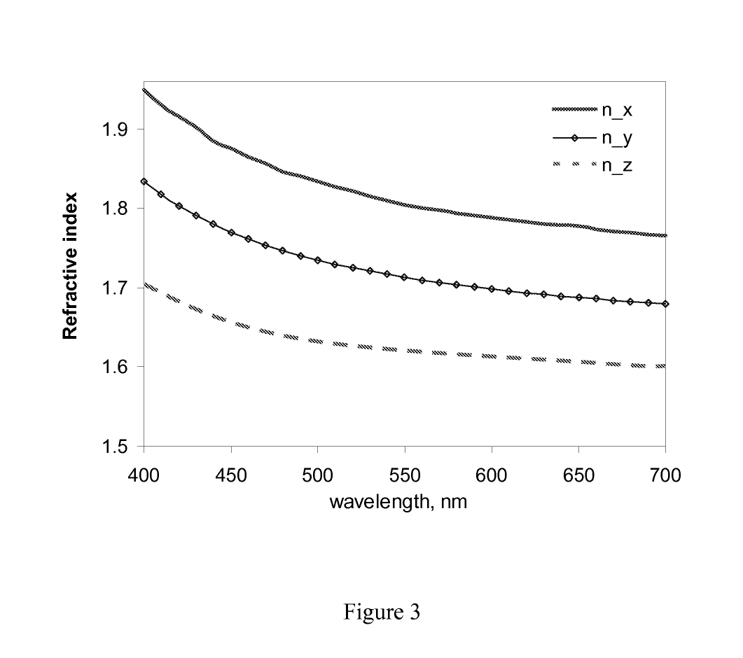

4.098 g (0.012 mol) of 4,4′-diaminobiphenyl-2,2′-disulfonic acid was mixed with 4.02 g (0.024 mol) of cesium hydroxide monohydrate in water (150 ml) in a 1 L beaker and stirred until the solid was completely dissolved. 3.91 g (0.012 mol) of sodium carbonate was added to the solution and stirred at room temperature until dissolved. Then toluene (25 ml) was added. Upon stirring the obtained solution at 7000 rpm, a solution of 2.41 g (0.012 mol) of terephthaloyl chloride (TPC) and 2.41 g (0.012 mol) of isophthaloyl chloride (IPC) in toluene (25 ml) were added. The resulting mixture thickened in about 3 minutes. The stirrer was stopped, 150 ml of ethanol was added, and the thickened mixture was crushed with the stirrer to form slurry suitable for filtration. The copolymer was filtered and washed twice with 150-ml portions of 90% aqueous ethanol. Obtained polymer was dried at 75° C. The material was characterized with absorbance spectrum presented at FIG. 3. Weight average molar mass of the copolymer samples was determined by gel permeation chromatography (GPC) analysis of the sample was performed with Hewlett Packard (HP) 1050 chromatographic system. Eluent was monitored with diode array detector (DAD HP 1050 at 305 nm). The GPC measurements were performed with two columns TSKgel G5000 PWXL and G6000 PWXL in series (TOSOH Bioscience, Japan). The columns were thermostated at 40° C. The flow rate was 0.6 mL/min. Poly(sodium-p-styrenesulfonate) was used as GPC standard. Varian GPC software Cirrus 3.2 was used for calculation of calibration plot, weight-average molecular weight, Mw, number-average molecular weight, Mn, and polydispersity (D=Mw/Mn).

### Example 2

The example describes preparation of a solid optical retardation layer of negative C-type with 2,2′-disulfo-4,4′-benzidine terephthalamide-isophthalamide copolymer (terephthalamide/isophthalamide molar ratio 50:50) prepared as described in Example 1.

2 g of poly(2,2′-disulfo-4,4′-benzidine terephthalamide-isophthalamide copolymer) cesium salt was dissolved in 100 g of de-ionized water (conductivity ˜5 μSm/cm). The suspension was mixed with a magnet stirrer. After dissolving, the solution was filtered with the hydrophilic filter with a 45 μm pore size and evaporated to the viscous isotropic solution of the concentration of solids of about 6%.

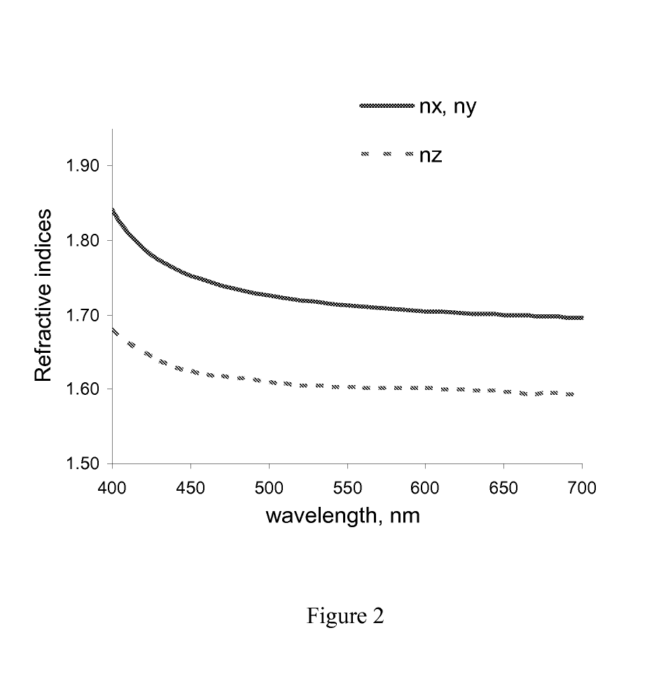

Fisher brand microscope glass slides were prepared for coating by soaking in a 10% NaOH solution for 30 min, rinsing with deionized water, and drying in airflow with the compressor. At temperature of 22° C. and relative humidity of 55% the obtained LLC solution was applied onto the glass panel surface with a Gardner® wired stainless steel rod #14, which was moved at a linear velocity of about 10 mm/s. The optical film was dried with a flow of the compressed air. The drying was at room temperature and took around several minutes. In order to determine optical characteristics of the solid optical retardation layer, transmission and reflection spectra were measured in a wavelength range from 400 to 700 nm using a Cary 500 Scan spectrophotometer. Optical transmission and reflection of the retardation layer was measured using light beams linearly polarized parallel and perpendicular to the coating direction (Tₚₐᵣ and Tₚₑᵣ respectively). The obtained data were used for calculation of the in-plane refractive indices (nₓ and n_{y}). Optical retardation spectra at different incident angles were measured in a wavelength range from 400 to 700 nm using Axometrics Axoscan Mueller Matrix spectropolarimeter, and out-of-plane refractive index (n_{z}) was calculated using these data and the results of the physical thickness measurements using Dectak³ST electromechanical profilometer. The refractive index spectral dependencies are presented in FIG. 2. The obtained solid optical retardation layer were characterized by thickness equal to approximately 800 nm and principle refractive indices which obey the following condition: n_{z}<n_{y}≈nₓ. Out-of-plane birefringence was equal to 0.11.

### Example 3

The example describes preparation of a solid optical retardation layer of Ac-plate type with 2,2′-disulfo-4,4′-benzidine terephthalamide-isophthalamide copolymer (terephthalamide/isophthalamide molar ratio 92:8) prepared as described in Example 1.

2 g of poly(2,2′-disulfo-4,4′-benzidine terephthalamide-isophthalamide copolymer) cesium salt produced as described in Example 1 was dissolved in 100 g of de-ionized water (conductivity ˜5 μSm/cm), and the obtained suspension was mixed with a magnet stirrer. After dissolving, the solution was filtered with the hydrophilic filter of a 45 μm pore size and evaporated to form viscous birefringent solution of concentration of solids of approximately 6%.

The coatings were produced and optically characterized as described in Example 2 with the Mayer rod #8 used for coating. The refractive index spectral dependencies are presented in FIG. 3. The obtained solid optical retardation layer was characterized by thickness of approximately 350 nm and principle refractive indices which obey the condition: n_{z}<n_{y}<nₓ. NZ-factor was equal to 2.0.

### Example 4

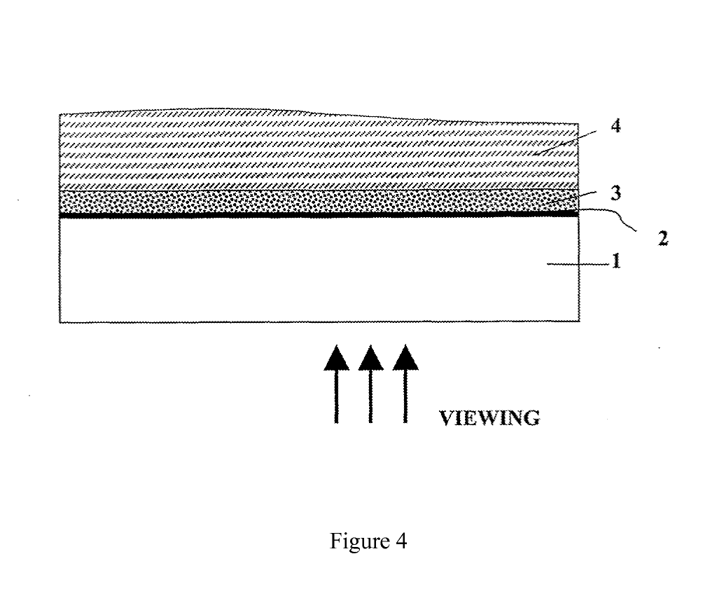

The example describes an optical film formed on substrate 1 as shown in FIG. 4. The film comprises retardation layer 2, adhesive layer 3, and protective layer 4. The substrate 1 is made of polyethylene terephthalate (PET) (e.g., Toray QT34/QT10/QT40, or Hostaphan 4607, or Dupon Teijin Film MT582). The substrate thickness is 30 to 120 um; reflective index is n=1.5 (Toray QT10), 1.7 (Hostaphan 4607), 1.51 Dupon Teijin Film MT582. The layer 2 is a solid optical retardation layer of negative C-type described in Example 2. The polymer layer 4 protects the optical layer from damage in the course of transportation of the optical film. This optical film is a semi-product, which can be used as a retarder for different applications, for example in liquid crystal displays. Upon removal of the protective layer 4, the film is applied onto the LCD glass with use of adhesive layer 3.

### Example 5

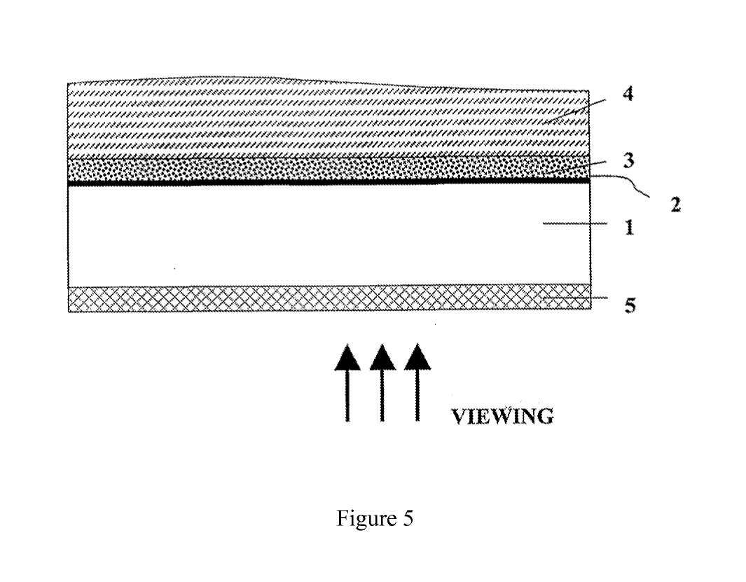

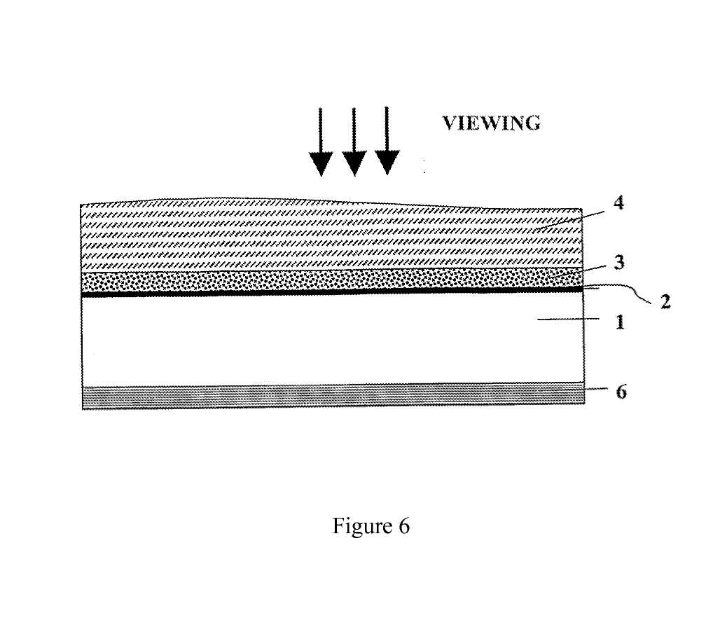

The optical film described in Example 4 may comprise an additional antireflection layer 5 formed on the substrate as shown in FIG. 5. For example, an antireflection layer 5 made of silicon dioxide SiO2 reduces by 30% the fraction of light reflected from the front surface. An additional reflective layer 6 may be formed on the substrate (FIG. 6). The reflective layer can be obtained, for example, by depositing an aluminum film. The film can then be used for example in a reflective LCD.

### Example 6

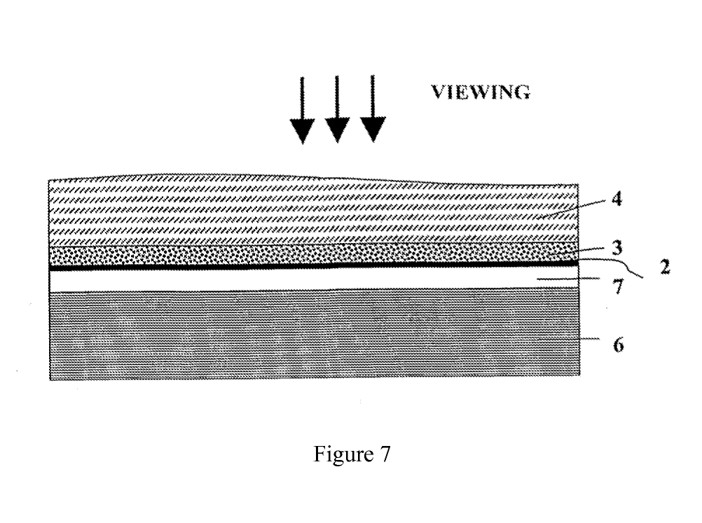

The example describes an optical film wherein the layer 2 is applied to a diffusive or specular reflector 6 which serves as a substrate (FIG. 7). The reflector layer 6 could be covered with a planarization layer 7. As the planarization layer it could be used polyurethane or acrylic or any other planarized layer.

While certain preferred embodiments of the invention have been specifically disclosed, it should be understood that the invention is not limited thereto as many variations will be readily apparent to those skilled in the art and the invention is to be given its broadest possible interpretation within the terms of the following claims.

What is claimed is:

1. An optical film comprising:
a substrate having front and rear surfaces, and
at least one solid optical retardation layer on the front surface of the substrate,
wherein the solid optical retardation layer comprises
organic rigid rod-like macromolecules based on 2,2′-disulfo-4,4′-benzidine terephthalamide-isophthalamide copolymer or its salt of the general structural formula I 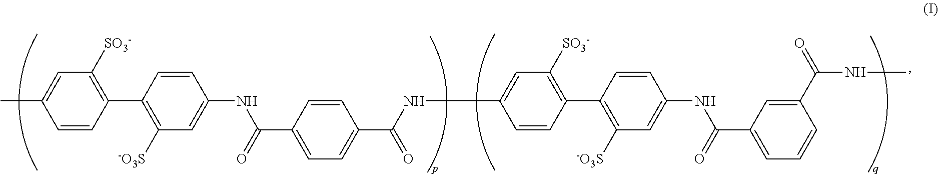
where p and q are numbers of the organic units in the rigid copolymer macromolecule which are in the range from 5 to 1000, the side-groups SO₃⁻ provide solubility of the organic rigid rod-like copolymer macromolecules or its salts in an aqueous solvent, and
counterions,
wherein at least one counterion is selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Al³⁺, Gd³⁺, Zr⁴⁺ and NH₄₋ₖQₖ⁺, where Q are independently selected from the list comprising linear and branched (C1-C20) alkyl, (C2-C20) alkenyl, (C2-C20) alkinyl, and (C6-C20)arylalkyl, and k is 0, 1, 2, 3 or 4,
and
wherein the solid optical retardation layer is a negative C-type or Ac-type plate substantially transparent to electromagnetic radiation in the visible spectral range.

2. An optical film according to claim 1, further comprising inorganic compounds which are selected from the list comprising hydroxides and salts of alkaline metals.

3. An optical film according to claim 1, wherein said solid retardation layer is an uniaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the following condition: n_{z}<n_{y}=n_{y}.

4. An optical film according to claim 1, wherein said solid retardation layer is a biaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the condition: n_{z}<n_{y}<nₓ.

5. An optical film according to claim 1, wherein the substrate material is selected from the list comprising polymer and glass.

6. An optical film according to claim 1, further comprising at least one interlayer formed between the substrate and the solid optical retardation layer.

7. An optical film according to claim 6, wherein a surface of the interlayer facing the solid optical retardation layer is hydrophilic.

8. An optical film according to claim 6, wherein a surface of the interlayer facing the solid optical retardation layer bears a relief.

9. An optical film according to claim 6, wherein a surface of the interlayer facing the solid optical retardation layer possesses a texture.

10. An optical film according to claim 6, wherein the interlayer is a planarization layer between the substrate and the solid optical retardation layer.

11. An optical film according to claim 1, wherein the rear surface of the substrate is further covered with an antireflection or antiflashing coating.

12. An optical film according to claim 1, further comprising an adhesive transparent layer formed on the solid optical retardation layer.

13. An optical film according to claim 12, further comprising a protective layer formed on the adhesive layer.

14. An optical film according to claim 1, wherein the substrate is a specular or diffusive reflector.

15. An optical film according to claim 1, wherein the substrate is a specular or diffusive transflector.

16. An optical film according to claim 1, wherein the substrate is a reflective polarizer.

17. An optical film according to claim 1, wherein the substrate transmission is not less than 90% in the visible range.

18. An optical film according to claim 1, wherein the substrate material is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester.

19. An optical film according to claim 1, wherein a thickness retardation Rₜₕ of the solid optical retardation layer is in the range from −210 nm to −320 nm, and the substrate is characterized by an in-plane retardation Rₒ which is in the range from 30 nm to 45 nm and by a thickness retardation Rₜₕ which is in the range from −120 nm to −230 nm.
